(19) United States
(12) Patent Application Publication
(10) Pub. No.: US 2012/0070105 A1
(43) Pub. Date: Mar. 22, 2012

(54) WOVEN POLYMERIC BAG AND A METHOD FOR CLOSING AND SEALING

(76) Inventor: James W. Abel, Collierville, TN (US)

(21) Appl. No.: 13/251,968

(22) Filed: Oct. 3, 2011

Related U.S. Application Data
(63) Continuation of application No. 11/441,517, filed on May 26, 2006.

(51) Int. Cl. B65D 30/10; B31B 49/04; B65D 30/20

(52) U.S. Cl. 383/120; 383/126; 493/231

(57) ABSTRACT

A method for sealing a bag which is formed from a tube of material and has front and rear walls, a pair of opposing, inward-tending gusset folds, each of these folds having front and rear vertical creases. The steps may include slitting each of the opposing front creases along longitudinal their axes to obtain front and rear plies. A first rearward fold is formed by rearwardly folding the rear ply together with the inward-tending gusset folds such that the inner surface of the rear ply is visible. A second rearward fold is formed by rearwardly folding the first fold until the inner surface of the rear ply lays against the rear wall of the bag.

This application is a continuation-in-part of and claims the benefit of and priority from U.S. application Ser. No. 11/441,517, filed May 26, 2006, which is hereby fully incorporated herein by reference.

### BRIEF DESCRIPTION OF THE DRAWINGS

The following disclosure as a whole may be best understood by reference to the provided detailed description when read in conjunction with the accompanying drawings, detailed description, abstract, and associated headings. Identical reference numerals when found on different figures identify the same elements or a functionally equivalent element. The elements listed in the abstract or written description that are not referenced nevertheless refer by association to the elements of the detailed description and associated disclosure. Certain embodiments are shown in the drawings. However, it is understood that the present disclosure is not limited to the arrangements and instrumentality shown in the attached drawings.

FIG. 1A is a perspective view of the rear of a bag.

FIG. 1B is a perspective view of the front of a bag.

FIG. 2 is an elevation view of one lateral side of the bag showing a slit in one crease.

FIG. 3 is an elevation view of the lateral side of the bag showing the portions to be folded grouped together.

FIG. 4 is an elevation view of the lateral side of the bag after a first rearward fold.

FIG. 5 is an elevation view of the lateral side of the bag after a second rearward fold.

FIG. 6 is an elevation view of the rear side of the bag after the first rearward fold.

FIG. 7 is an elevation view of the rear side of the bag after the second rearward fold.

FIG. 8 is a perspective view of a portion of the bag illustrating one embodiment of this disclosure.

FIG. 9 is an elevation view of a partial section of the bag illustrating one embodiment of this disclosure.

### DETAILED DESCRIPTION

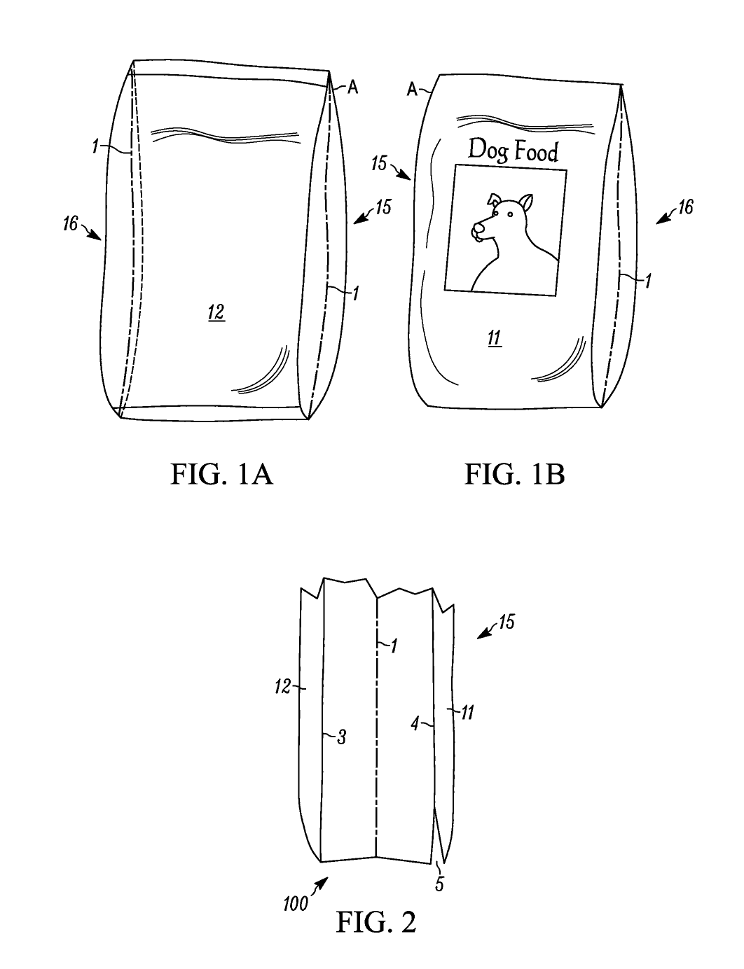

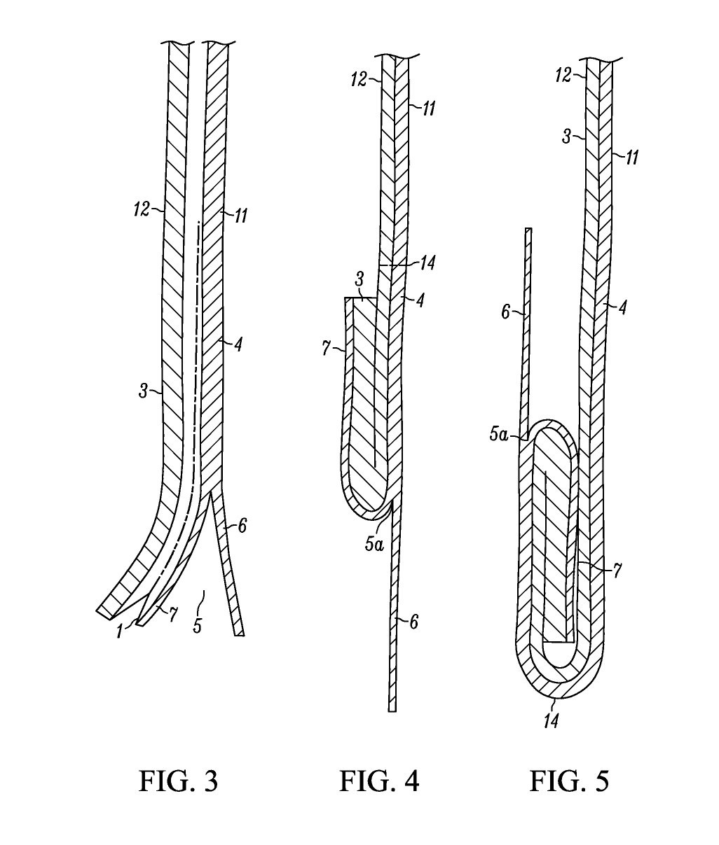

The various embodiments of the present invention and their advantages are best understood by referring to FIGS. 1 through 9 of the drawings. The elements of the drawings are not necessarily to scale, emphasis instead being placed upon clearly illustrating the principles of the invention. Throughout the drawings, like numerals are used for like and corresponding parts of the various drawings.

The drawings represent and illustrate examples of the various embodiments of the invention, and not a limitation thereof. It will be apparent to those skilled in the art that various modifications and variations can be made in the present inventions without departing from the scope and spirit of the invention as described herein. For instance, features illustrated or described as part of one embodiment can be included in another embodiment to yield a still further embodiment. Moreover, variations in selection of materials and/or characteristics may be practiced to satisfy particular desired user criteria. Thus, it is intended that the present invention covers such modifications as come within the scope of the features and their equivalents.

Furthermore, any reference in the specification to “an embodiment,” “one embodiment,” “various embodiments,” or any variant thereof means that a particular feature or aspect of the disclosure described in conjunction with the particular embodiment is included in at least one embodiment of the present disclosure. Thus, the appearance of the phrases “in one embodiment,” “in another embodiment,” or variations thereof in various places throughout the specification are not necessarily all referring to its respective embodiment.

Shown in FIGS. 1A and 1B is one embodiment of a bag A of the type often used for animal feed, or similar types of contents. Bag A is preferably constructed from a durable, flexible multi-layered material suitable for the containment and storage of such contents or the like. One non-limiting example of such a material may include a single or plurality of layers in any combination of polypropylene, oriented polypropylene, blends of polypropylene, woven polypropylene or other similar advantageous materials that provide the intended functionality, etc. Other examples of such material may be configured from a single or multiple layers in any combination of any of the foregoing or may also include in any combination polyethylene, blends of polypropylene, paper or any other conventional material advantageous for the intended functionality or the like, etc. Bag A may be formed from a tube-like structure (regardless if originally formed as a tube or made into a tube after initial formation) which is cut to size. Then one end is closed and sealed, the bag is filled, and the opposing end is then sealed. For orientational reference, bag A may include a front wall 11, and an opposing rear wall 12. The front wall 11 may be considered the side on which prominent displays labeling or indicia comprising, for example, graphic designs, trademarks, and the like, a notional example of which is represented in FIG. 1B. For storage purposes when the bag is empty, bag A is collapsible, having an inwardly-projecting gusset-type folds 1 formed on each of the lateral sides 15, 16 of the bag A. FIG. 2 illustrates an end portion 100 of an unclosed bag A, viewed from the perspective of a gusset fold 1, where two outer creases 3, 4 are defined in the lateral side 15 of the bag A to forming a gusset fold 1 (having two inwardly tending panels, one on either side of the vertex of the fold extending to the respective crease 3, 4).

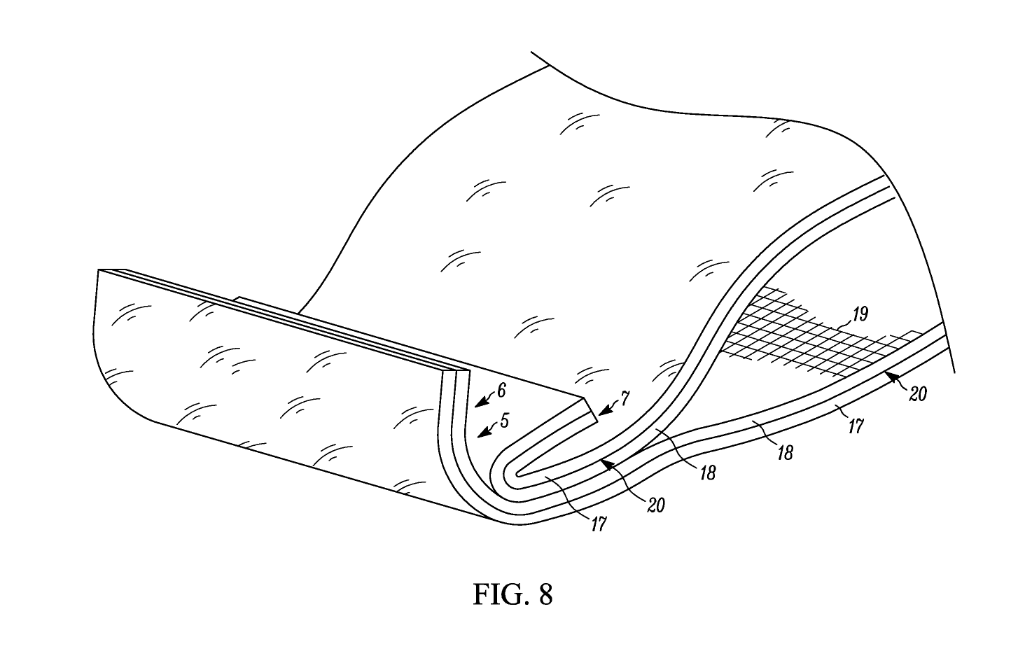

FIG. 8 is a perspective view of a portion of the bag A illustrating one embodiment of the present disclosure, similar to and as described with respect to FIGS. 2-7. The material of construction for the walls 11, 12 of the bag A in this embodiment may include, among other things, a polypropylene layer 17 oriented as an outside, exterior layer of the bag A. Inside or interiorly of the extension of polypropylene layer 17 may be a woven polypropylene layer 18 that are characteristic of such material. Note cross-hatchings 19 on woven polypropylene layer 18, which is characteristic of such material. Optionally, an intermediate layer 20 may be disposed adjacent the woven polypropylene layer 18, preferably between the outer, polypropylene layer 17 and the woven polypropylene layer 18. Intermediate layer 20 may be paper, polyethylene, blends of polyethylene, polypropylene, blends of polypropylene or any other suitable material or combinations for the intended functionality as described herein. Woven polypropylene layer 18 provides strength to the outer polypropylene layer 17. Another layer may be present as the innermost layer of the bag which contacts the contents of the bag and may be made of material that is compatible with the contents and may absorb or block materials leaching from the contents such as oil, fat, or moisture. The layer may be, for example, paper, Saran, and other compatible materials.

In one embodiment, the outer, polypropylene layer 17, inner, woven polypropylene layer 18 and the intermediate layer 20 may be connected at distal ends, over their entire surface area (such as by lamination, adhesive, etc.) or at spaced locations along or about the surface area of the layers and the adjacent layers may be connected differently than other adjacent layers. For example, the inner, woven polypropylene layer 18 may be laminated over its entire surface area to the intermediate layer 20 and the opposite side of the intermediate layer 20 may be connected to the outer, exterior polypropylene layer 17 only at the distal ends thereof or the end margin portions thereof. Other examples and embodiments or sections are within the teachings of the present disclosure.

FIG. 9 is an elevation view of a portion of one embodiment of the present disclosure, similar to and as discussed with respect to FIGS. 2-7. In this embodiment, a polypropylene layer 66 is oriented as the outer, exterior layer of the bag. Inside of the polypropylene layer 66 is woven polypropylene inner layer 76. Note cross-hatchings on woven polypropylene layer 76. An intermediate or extrusion layer 68 may be adjacent woven polypropylene inner layer 76. Intermediate layer 68 with end 74 may be polypropylene, polyethylene, blends of polyethylene, polypropylene, blends of polypropylene or any other suitable material or combinations for the intended functionality as described herein, and is used to seal the outside polypropylene layer 66 to inside woven layer 76, such that the outer polypropylene layer 66 is bonded, laminated or otherwise connected on its surface area to the intermediate layer 68 and likewise with the woven polypropylene inner layer 76 and the intermediate layer 68. Woven polypropylene inner layer 76 provides strength to the outer layer, polypropylene layer 66. Another layer may be present as the innermost layer of the bag which contacts the contents of the bag and may be made of material that is compatible with the contents and may absorb or block materials leaching from the contents such as oil, fat, or moisture. The layer may be, for example, paper, Saran, and other compatible materials.

In one embodiment, as shown, in FIGS. 2-9, a slit 5 may be made in an outer crease 4 along a longitudinal axis of such crease, preferably the outer crease adjacent the front wall 11 of the bag A for the advantages described herein. The slit 5 defines a forward ply 6 (including the front wall 11) and a rearward ply 7 (including the rear wall 12 and the gusset fold 1). The forward ply 6 is kept in place stationary by any suitable conventional manner or apparatus, while a first rearward fold (see, FIG. 4) is formed by creasing and folding the rearward ply 7 approximately at or adjacent the vertex 5a of slit 5. A second rearward fold (see, FIG. 5) is formed by creasing and folding the forward ply 6 and rearward ply 7 together, simultaneously approximately at or adjacent the level reached by the ends of the plies 14 (indicated by ghosted line) after the first rearward fold.

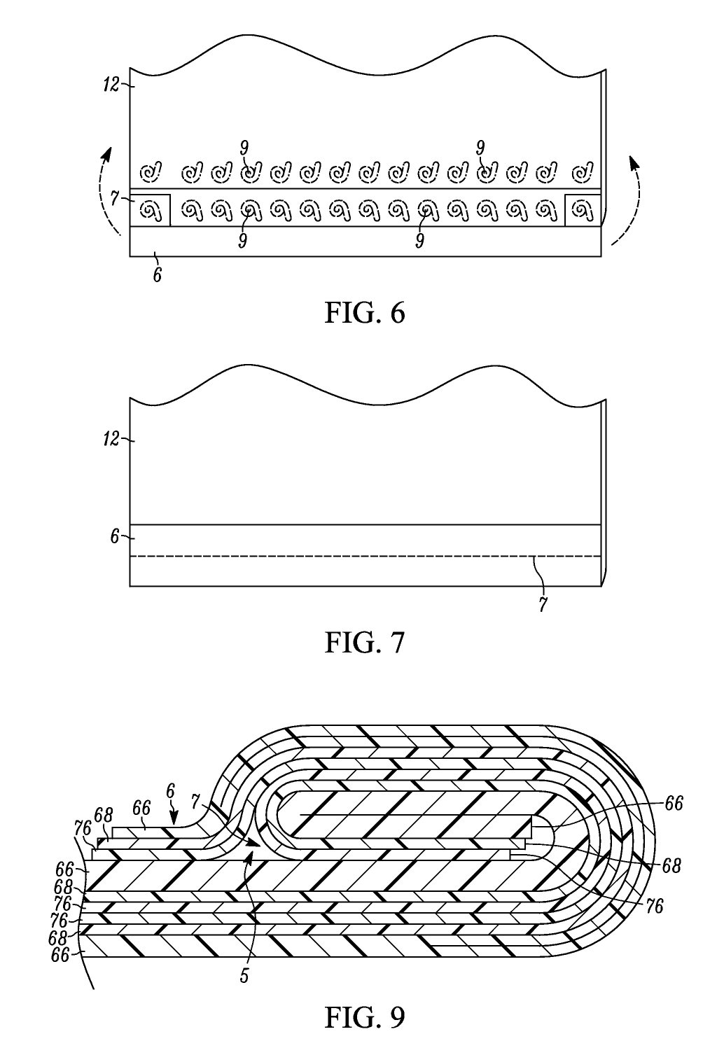

Referring to FIGS. 6 and 7, means for securing the fold is illustrated in FIG. 6 where after the first rearward fold, adhesive 9 may be deposited on the wall 12 that defines or is disposed adjacent the inner surface of rearward ply 7. Adhesive 9 may be any suitable adhesive for securing or bonding the material to itself. By way of non-limiting example, adhesive 9 could be a hot melt adhesive known to those skilled in the relevant arts. In another embodiment, adhesive 9 is also deposited upon the rear surface of the bag A within the area at which the inner surface of plys 7 and 6 contact it.

Additionally, embodiments of a bag and/or bag closure can include the adhesive components of rosin ester and ethylene vinyl acetate. The hot melt adhesive can be supplied, for example, as Product No. 70-4467 from NATIONAL STARCH AND CHEMICAL COMPANY, 10 Finderne Avenue, Bridgewater, N.J. 08807. Alternatively, for example, the adhesive can further include a component selected from the group consisting of: styrene-isoprene-styrene copolymers, styrene-butadiene-styrene copolymers, ethylene ethyl acrylate copolymers, polyurethane reactive adhesives, tackifiers, waxes, paraffin, antioxidants, plasticizers, plant sterols, terpene resins, polyterpene resins, turpentines, hydrocarbon resins, resin acids, fatty acids, polymerized rosins, and polyamide adhesives.

Within the adhesives industry hot melt adhesives are known to have good performance and usage benefits, as understood by those skilled in the art. Hot melt adhesives are solvent-free adhesives, that are characteristically solid at temperatures below 180° F., are low viscosity fluids above 180° F., and rapidly set upon cooling. The development of hot melt adhesive technology stemmed from the previous use of molten wax for bonding. Hot melt adhesives are used in a variety of manufacturing processes. There are a number of hot melt adhesives in use, with the most common being those used for hot melt pressure sensitive adhesive applications: ethylene vinyl acetate (EVA) copolymers, compatible with paraffin, the original hot melt; styrene-isoprene-styrene (SIS) copolymers; styrene-butadiene-styrene (SBS) copolymers; ethylene ethyl acrylate copolymers (EEA); and polyurethane reactive (PUR).

FIG. 7 depicts the completed folded closure after the second inward fold. Inner surface of rearward ply 7 (represented by dashed line) is bonded to rear wall 12 of bag A. Front ply 6 extends roughly vertically with respect to the bag, beyond the crease (adjacent vertex 5a) of the first rearward fold. FIG. 1B shows an exemplary bag A from the front perspective where it is apparent that an observer cannot see any seams, seals, or closures, thus presenting a more aesthetically pleasing package to the customer.

As described above and shown in the associated drawings, the present invention comprises a method for closing and sealing a tube-formed bag and bags produced thereby. While particular embodiments of the invention have been described, it will be understood, however, that the invention is not limited thereto, since modifications may be made by those skilled in the art, particularly in light of the foregoing teachings. It is, therefore, contemplated by the following claims to cover any such modifications that incorporate those features or those improvements that embody the spirit and scope of the present invention.

What is claimed is:

1. A flexible bag formed from a tube consisting essentially of a material and having a front side and a rear side, and a pair of opposing, inward-tending gusset folds, each of said folds having front and rear vertical creases, said bag having at least one sealed closure formed by a method comprising the steps of:
a. slitting each of said front creases along longitudinal axes thereof, thereby obtaining front and rear plies;
b. forming a first rearward fold by rearwardly folding said rear plies together with said rear vertical creases such that an inner surface of said rear ply is visible; and
c. forming a second rearward fold by rearwardly folding said first fold wherein said inner surface of said rear ply lays against said rear side of said bag, wherein said material has an outer layer of polypropylene and an inner layer of woven polypropylene, with an intermediate layer of polyethylene, polypropylene, or a blend of polyethylene and polypropylene sealed to and positioned between the outer and inner layers.

2. The bag of claim 1, wherein said method further comprises the step of depositing an adhesive upon said inner surface of said rear ply.

3. The bag of claim 2, wherein said method further comprises the step of depositing said adhesive upon the rear side of said bag wherein said inner surface lays against it.

4. A bag formed from a tube consisting essentially of a polyolefin material and having a front side and a rear side, and a pair of lateral, opposing, inward tending gusset folds, each of said folds having front and rear vertical creases, said bag formed by a method comprising the steps of:
a. parting said material longitudinally along said front crease;
b. rolling a rear ply resulting from said step of parting along with rear portion of said bag proximal to said rear ply such that a surface of said rear ply opposes the rear side of said bag; and
c. applying an adhesive element to said surface, said adhesive being for the bonding of said surface with said rear side, wherein said material has an outer layer of polypropylene and an inner layer of woven polypropylene, with an intermediate layer of polyethylene, polypropylene or a blend of polyethylene and polypropylene sealed to and positioned between the outer and inner layers.

5. A flexible bag comprising:
a tube consisting essentially of a polyolefin material comprising:
a front side;
a rear side;
a pair of opposing, inward-tending gusset folds, each of said folds having front and rear vertical creases and each of said folds between said front side and said rear side;
at least one sealed closure comprising:
a front ply and a rear ply, said front ply and said rear ply being separated by a pair of slits along said front creases along longitudinal axes thereof, and said rear ply having an outer and inner surface;
a first rearward fold causing said outer surface of said rear ply to oppose a first portion of the rear side of the bag; and
a second rearward fold causing said inner surface of said rear ply to oppose a second portion of the rear side of the bag, wherein said material is an outer layer of polypropylene and an inner layer of woven polypropylene, with an intermediate layer of polyethylene, polypropylene, or a blend of polyethylene and polypropylene sealed to and positioned between the outer and inner layers.

6. The flexible bag of claim 5 further comprising an adhesive upon said inner surface of said rear ply.

7. The flexible bag of claim 6 further comprising the adhesive upon the rear side of said flexible bag where said inner surface lays against it.

8. A flexible bag formed from a tube consisting essentially of a material and having a front side and a rear side, and a pair of opposing, inward-tending gusset folds, each of said folds having front and rear vertical creases, said bag having at least one sealed closure formed by a method comprising the steps of:
a. slitting each of said front creases along longitudinal axes thereof, thereby obtaining front and rear plies;
b. forming a first rearward fold by rearwardly folding said rear plies together with said rear vertical creases such that an inner surface of said rear ply is visible; and
c. forming a second rearward fold by rearwardly folding said first fold wherein said inner surface of said rear ply lays against said rear side of said bag, wherein said material has an outer layer of polypropylene and an inner layer of woven polypropylene.

9. The bag of claim 8, wherein said method further comprises the step of depositing an adhesive upon said inner surface of said rear ply.

10. The bag of claim 9, wherein said method further comprises the step of depositing said adhesive upon the rear side of said bag wherein said inner surface lays against it.

11. A bag formed from a tube consisting essentially of a polyolefin material and having a front side and a rear side, and a pair of lateral, opposing, inward-tending gusset folds, each of said folds having front and rear vertical creases, said bag formed by a method comprising the steps of:
a. parting said material longitudinally along said front crease;
b. rolling a rear ply resulting from said step of parting along with rear portion of said bag proximal to said rear ply such that a surface of said rear ply opposes the rear side of said bag; and
c. applying an adhesive element to said surface, said adhesive being for the bonding of said surface with said rear side, wherein said material has an outer layer of polypropylene and an inner layer of woven polypropylene.

12. A flexible bag comprising:
a tube consisting essentially of a polyolefin material comprising:
a front side;
a rear side;
a pair of opposing, inward-tending gusset folds, each of said folds having front and rear vertical creases and each of said folds between said front side and said rear side;
at least one sealed closure comprising:
a front ply and a rear ply, said front ply and said rear ply being separated by a pair of slits along said front creases along longitudinal axes thereof, and said rear ply having an outer and inner surface;
a first rearward fold causing said outer surface of said rear ply to oppose a first portion of the rear side of the bag; and
a second rearward fold causing said inner surface of said rear ply to oppose a second portion of the rear side of the bag, wherein said material is an outer layer of polypropylene and an inner layer of woven polypropylene.

13. The flexible bag of claim 12 further comprising an adhesive upon said inner surface of said rear ply.

14. The flexible bag of claim 13 further comprising the adhesive upon the rear side of said flexible bag where said inner surface lays against it.

15. A flexible bag comprising:
a tube consisting essentially of a polyolefin material comprising:
a front side;
a rear side;
a pair of opposing, inward-tending gusset folds, each of said folds having front and rear vertical creases and each of said folds between said front side and said rear side;
at least one sealed closure comprising:
a front ply and a rear ply, said front ply and said rear ply being separated by a pair of slits along said front creases along longitudinal axes thereof, and said rear ply having an outer and inner surface;
a first rearward fold causing said outer surface of said rear ply to oppose a first portion of the rear side of the bag; and
a second rearward fold causing said inner surface of said rear ply to oppose a second portion of the rear side of the bag, wherein said material is an outer layer of woven polypropylene and an inner layer of polypropylene, with an intermediate layer of polyethylene, polypropylene, or a blend of polyethylene and polypropylene sealed to and positioned between the outer and inner layers.

16. The flexible bag of claim 15 further comprising an adhesive upon said inner surface of said rear ply.

17. The flexible bag of claim 16 further comprising the adhesive upon the rear side of said flexible bag where said inner surface lays against it.

18. A flexible bag comprising:
a tube consisting essentially of a polyolefin material comprising:
a front side;
a rear side;
a pair of opposing, inward-tending gusset folds, each of said folds having front and rear vertical creases and each of said folds between said front side and said rear side;
at least one sealed closure comprising:
a front ply and a rear ply, said front ply and said rear ply being separated by a pair of slits along said front creases along longitudinal axes thereof, and said rear ply having an outer and inner surface;
a first rearward fold causing said outer surface of said rear ply to oppose a first portion of the rear side of the bag; and
a second rearward fold causing said inner surface of said rear ply to oppose a second portion of the rear side of the bag, wherein said material is an outer layer of woven polypropylene and an inner layer of polypropylene.
